(19) United States
(12) Patent Application Publication
(10) Pub. No.: US 2013/0198217 A1
(43) Pub. Date: Aug. 1, 2013

(54) TECHNIQUES FOR TESTING RULE-BASED QUERY TRANSFORMATION AND GENERATION

(71) Applicants: Puneet Narula, Redmond, WA (US); Pedro DeRose, Redmond, WA (US); Vicktoriya Taranov, Redmond, WA (US)

(72) Inventors: Puneet Narula, Redmond, WA (US); Pedro DeRose, Redmond, WA (US); Vicktoriya Taranov, Redmond, WA (US)

(73) Assignee: MICROSOFT CORPORATION, Redmond, WA (US)

(21) Appl. No.: 13/360,412

(22) Filed: Jan. 27, 2012

(51) Int. Cl. G06F 17/30

(52) U.S. Cl. 707/759; 707/E17.069

(57) ABSTRACT

Techniques for testing rule-based query transformation and generation are described. An apparatus may comprise: a context component operative to receive a search query and determine a query execution context; a rules component operative to receive the determined query execution context and the search query and to determine a set of fired rules; a transformation component operative to receive the set of fired rules, the search query, and the query execution context and determine one or more transformed queries; and a results component operative to determine a search query analysis based on the one or more transformed queries, wherein the search query analysis does not depend on performing a search using the search query. Other embodiments are described and claimed.

### BACKGROUND

Many search applications execute queries in a pipeline. During the flow of a query through the pipeline a set of actions may be applied to the query. Making changes to these actions can be a difficult process. A developer or administrator may have to spend considerable time to customize the actions applied to the query. A developer may be limited in what information they receive from a search application or search system to guide them in the customization of these actions. It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques for testing rule-based query transformation and generation. Some embodiments are particularly directed to techniques for testing rule-based query transformation and generation in a test mode for a search system. In one embodiment, for example, an apparatus may comprise: a context component operative to receive a search query and determine a query execution context; a rules component operative to receive the determined query execution context and the search query and to determine a set of fired rules; a transformation component operative to receive the set of fired rules, the search query, and the query execution context and determine one or more transformed queries; and a results component operative to determine a search query analysis based on the one or more transformed queries, wherein the search query analysis does not depend on performing a search using the search query. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a search query test system for rule-based query transformation and generation.

FIG. 2 illustrates an embodiment of a first logic flow for the system of FIG. 1.

FIG. 3 illustrates an embodiment of a second logic flow for the system of FIG. 1.

FIG. 4 illustrates a search test window and test results for the system of FIG. 1.

FIG. 5 illustrates an embodiment of a centralized system for the system of FIG. 1.

FIG. 6 illustrates an embodiment of a distributed system for the system of FIG. 1.

FIG. 7 illustrates an embodiment of a computing architecture.

FIG. 8 illustrates an embodiment of a communications architecture.

### DETAILED DESCRIPTION

A search system is arranged to allow a user to configure a search pipeline. Generally, the user configures a set of condition-action rules over queries that may specify rule conditions and contextual information to which the rules apply. Rule conditions are a predicate over a query and some contextual information such as settings, and the like. Rule actions, which are taken when the predicate is true, may transform the query and/or generate parallel queries that are transformed versions of the original query. By using these rule actions, a user may configure a search system to expand or modify searches so as to increase the usefulness of the received search results.

Generally, processing a query comprises four steps: preparing the context, evaluating the rules, executing the queries, and preparing results. However, in test scenarios, it may not be necessary or desirable to actually execute the queries. If a user is configuring a search pipeline, they may be interested in testing the transformation of queries or the generation of additional queries without having any interest in the actual search results of a query. If the user has no interest in the actual search results, performing the search adds to the processing load on the search system without any benefit. As such, processing a query using the search pipeline, but without actually performing the search using the search query or any transformed queries produced from the search query, will result in greater efficiency in testing a search system.

Query rules may be configured to perform different actions. According to an embodiment, a query rule comprises a query class and a set of actions. The query class comprises a set of query conditions and a set of context conditions. The query conditions are predicates on the query. A query class can comprise multiple conditions on the query itself and on context. The context conditions are predicates on contextual information such as the source or category in which the query was performed. A query class may trigger multiple actions without re-entering its conditions. There may be many types of different actions that are associated with a query. According to an embodiment, there are two types of actions: transforming the search query into a different query and generating one or more new queries from the search query. Other actions may be defined. In some embodiments, generating one or more new queries from the search query may comprise generating a plurality of federated queries.

Changing the query includes specifying a query transformation that is applied to the original query. The query transforms may provide a variety of transformations to a query. For example, one of the transformations is to use a different result source. For example it may query for results from the internet, or another search application, such as a people search. The transforms may apply to transformation of user queries and/or system queries.

A user may configure a large number of rules. According to an embodiment, the rules are unordered and are evaluated in parallel, and all rules where the query class matches are fired. In alternative embodiments, the rules may be ordered. In some embodiments, the rules may ordered within a group, wherein an order is specified for the evaluation of rules within the group. Generally, a user configuring the pipeline does not have to worry about managing rule interactions. A user may, however, configure the interaction of the rules. The user can move a set of rules into an ordering group. Within the ordering group, the user may manually order rules as well as specify that when a particular rule fires then the other rules in the group should not fire (which may be useful to help to ensure that only one “change the query” action fires).

According to an embodiment, query conditions comprise three variables for setting including SearchTerms, SubjectTerms, and ContextTerms. SearchTerms is the full original query. SubjectTerms is the terms in the original query that represent what the user is actually searching for. ContextTerms are terms in the original query that provide context for the main terms (e.g. by indicating the action the user wanted to perform with them, or by specifying an additional filter). Each specified query condition assigns these variables as appropriate. Then, the actions can make use of any variable that is set by the conditions.

Query rules can be set at different hierarchical levels. For example, in a cloud based service, query rules may be configured at the top Search Service level, a tenant level, a site collection level and a site level. It will be appreciated that the search system may be stored at one or more locations and may be accessed from one or more different locations. For example, a user may access a cloud-based pipeline manager using a web browser , using a locally installed pipeline manager that is configured to communicate with the search service application, and/or a combination of a cloud based service and an installed pipeline manager.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

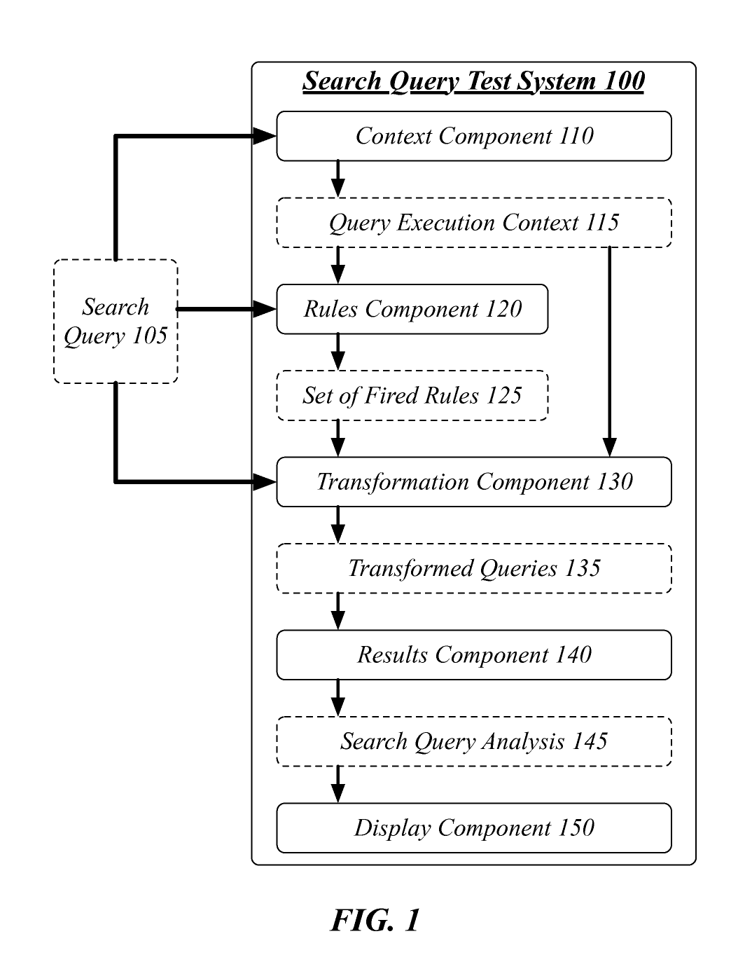

FIG. 1 illustrates a block diagram for a search query test system 100. In one embodiment, the search query test system 100 may comprise one or more components. Although the system 100 shown in FIG. 1 has a limited number of elements in a certain topology, it may be appreciated that the system 100 may include more or less elements in alternate topologies as desired for a given implementation. In some embodiments, the search query test system 100 may comprise a context component 110 operative to receive a search query 105 and determine a query execution context 115; a rules component 120 operative to receive the determined query execution context 125 and the search query 105 and to determine a set of fired rules 125; a transformation component 130 operative to receive the set of fired rules 125, the search query 105, and the query execution context 115 and determine one or more transformed queries 135; a results component 140 operative to determine a search query analysis 145 based on the one or more transformed queries, wherein the search query analysis 145 does not depend on performing a search using the search query 105; and a display component 150 operative to receive the search query analysis 145 and display the search query analysis 145 for a user, the displayed search query analysis 145 showing the set of fired rules 125 in association with the one or more transformed queries 135.

In general, a context component 110 may be operative to receive a search query 105 and determine a query execution context 115. According to an embodiment, a query may be run in a test or evaluation mode. When the query is in an evaluation mode, different configuration information is obtained than if the system were in an execution mode. The user's pipeline configuration is obtained (either from a cache or, if it is not cached, from storage). In some embodiments, when the search query test system 100 is run in test mode, the cache may be bypassed or ignored, loading the query execution context 115 from storage so that any recently-updated rules—such as those rules the user intends to test—will be included in the query execution context 115. The context related to the query also specifies rules and/or actions to apply to the received query. The context conditions are used to decide whether the behavior rule is appropriate for the context. For example, the context may refer to a source that the rule is associated with, a user context object to apply, or an app id (if one were available). Context conditions derive their context from any available query property. A context condition is a Boolean expression over context. For example, the following Boolean expression may be a context condition:

(Source=people AND gender!=male AND resultsrequested>500) (recommenderfillin) (usercontext=dev and area=USA)

In some embodiments, when run in a test mode, all rules, including inactive rules, may be considered to be part of the query execution context 115. An inactive rule may comprise a rule that would not be considered during execution mode—a mode in which a search would be performed using the search system. This may allow for a user to create rules for testing, set those rules as inactive—so that the rules will not be considered for users performing searches as part of the normal use of the search system, but still be tested as part of the test.

In general, the rules component 120 may be operative to receive the determined query execution context 125 and the search query 105 and to determine a set of fired rules 125. Query rules may fire on a search query 105 which has no user query text, but other “context” (such as may be represented as properties of a query object) that could be matched as part of the rules. Rules whose predicates do not match the query's determined contextual information are discarded from consideration. Rules whose conditions do not match the query's text are discarded from consideration. The remaining rules, whose predicates are true for both the query's contextual information and query text, are determined to be fired. According to an embodiment, a determination is made as to whether rules are to be evaluated for the received query. For example, rules may be evaluated for simple keyword queries but not for advanced queries since a user performing an advanced query may be interested in receiving just the standard search results. According to an embodiment, the rules are evaluated for all received queries. In some embodiments, as discussed above in regards to test mode, the determined set of fired rules 125 may comprise one or more inactive rules.

In general, the transformation component 130 may be operative to receive the set of fired rules 125, the search query 105, and the query execution context 115 and determine one or more transformed queries 135. Determining the transformed queries 135 comprises applying the actions of each of the fired rules 125 to the search query 105. These actions can transform the query and/or generate parallel queries that are transformed versions of the original query.

In general, the results component 140 may be operative to determine a search query analysis 145 based on the one or more transformed queries, wherein the search query analysis 145 does not depend on performing a search using the search query 105. The search query analysis 145 may generally comprise: the fired rules 125, variables with their evaluated values, and actions which would be executed if a full search were to performed, such as if the search system were not in test mode.

In general, the search query analysis does not depend on performing a search using the search query in that neither the original search query nor any of the transformed queries will be run against a search engine to find results. Instead, rather than performing a search, the transformed queries—and the fired rules and context variables which created them—are displayed as the result of a test mode. This may allow the user of a system to perform a test in which tests the transformation of queries without placing a load upon the search portion of a search system.

In general, the display component 150 may be operative to receive the search query analysis 145 and display the search query analysis 145 for a user, the displayed search query analysis 145 showing the set of fired rules 125 in association with the one or more transformed queries 135. In some embodiments, the displayed search query analysis 145 may comprise variables with their evaluated values, may make a visual distinction for inactive rules (such as by labeling the rules as inactive or displaying them in a particular color or shade), may make a visual distinction for rules stopped by other rules (such as by labeling the rules as stopped or displaying them in a particular color or shade), and may display any actions that will be executed for the fired rules.

As previously discussed, rules may be placed into a group by a user. For rules in a group, a user may specify that when a particular rule fires then the other rules in the group should not fire. In some embodiments, this may comprise one or more of the rules within the group containing a stop action as one of the plurality of actions initiated by the rule if its predicate is true. A stop action specifies that no more rules within the group should be evaluated. In some embodiments, each rule within a group may be specified as having exactly one of a stop action or continue action associated with it, wherein a stop action specifies that no further rules in the group should be evaluated if the stop action is initiated (because the predicate of the rule with which it is associated is evaluated as true), and a continue action specifies that the evaluation of rules within the group may continue even if the predicate of the associate rule is evaluated as true.

It will therefore be appreciated that as groups are typically ordering groups—which specify an ordering for the evaluation of the rules within the group—a user creating an ordering group with stop and continue actions can create a logic flow within the group where in some scenarios only a subset of the rules within the group will be considered for evaluation. If a rule with an associated stop action has its predicate evaluated as true then those rules later in the ordering will not have their predicates evaluated in the performance of the test-mode query analysis. These rules may be referred to as being conditionally inactive. In some embodiments, the search query analysis may include a display of those rules which have been rendered conditionally inactive by a stop action of a fired rule within their group. This display may include making a visual distinction for these conditionally inactive rules so as to indicate that they were rendered conditionally inactive, such as by using a color or shade specific to conditionally-inactive rules, by associating with them a symbol, icon, or insignia specific to conditionally-inactive rules, or by labeling them with the text “conditionally inactive” or an equivalent specific to conditionally-inactive rules. Alternatively or additionally, some of these visual distinctions may be shared with other inactive rules—inactive rules others than those which are conditionally inactive—such as using a common shade of grey, but then specifically labeling conditionally inactive rules with the text “conditionally inactive” or an equivalent. In some embodiments, a user may be able to specify whether they wish to be shown conditionally inactive rules when performing a test-mode query analysis.

As such, in some embodiments, the query execution context may include an ordering group comprising a plurality of rules with a specified order of evaluation. At least one of the plurality of rules within the ordering group may therefore be fired and have associated with it a stop action. As such, the search query analysis may include an indication that one or more of the plurality of rules within the ordering group was rendered conditionally inactive by the stop action. As a consequence, the display search query analysis may include a display of the one or more conditionally inactive rules, which may include an indicator or other visual distinction to mark the conditionally inactive rules as being conditionally inactive.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

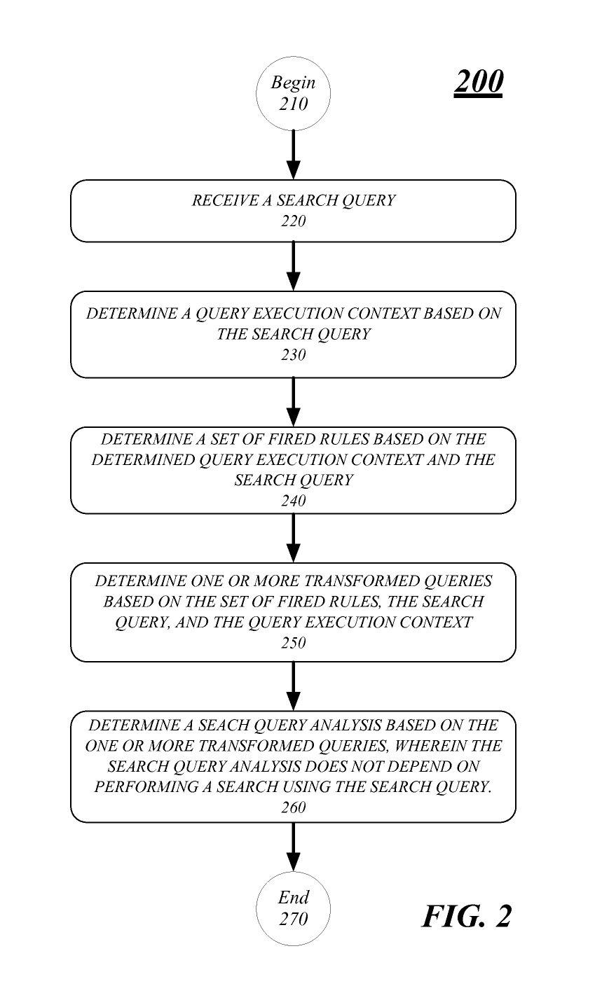

FIG. 2 illustrates one embodiment of a first logic flow 200. The first logic flow 200 may be representative of some or all of the operations executed by one or more embodiments described herein, such as the search query test system 100, for example.

Operations for the first logic flow 200 are initiated at block 210.

In block 220, a search query is received. For example, a user may enter a search query into the field of a user interface for configuring query rules for a search system, the search system configured to run in a test mode.

In block 230, a query execution context is determined based on the search query. Determining the query execution context may comprise loading the query execution context from storage. The query execution context may comprise a set of rules.

In block 240, a set of fired rules is determined based on the determined execution context and the search query. Determining the set of fired rules may comprise determining which of the set of rules would fire given the context of the query and search terms contained within the query.

In block 250, one or more transformed queries are determined based on the set of fired rules, the search query, and the query execution context. A query transformation may comprise a number of different types of transformations. For example, a source that is associated with the query can be replaced, the query may be reformulated based on defined rules, additional queries may be formulated, and different sources may be selected.

In block 260, a search query analysis is determined based on the one or more transformed queries, wherein the search query analysis does not depend on performing a search using the search query. The search query analysis may generally comprise the fired rules, variables with their evaluated values, and actions which would be executed if a full search were to performed, such as if the search system were not in test mode. In general, the search query analysis does not depend on performing a search using the search query in that neither the original search query nor any of the transformed queries will be run against a search engine to find results. Instead, rather than performing a search, the transformed queries—and the fired rules and context variables which created them—are displayed as the result of a test mode. This may allow the user of a system to perform a test in which tests the transformation of queries without placing a load upon the search portion of a search system.

In block 270, the logic flow ends.

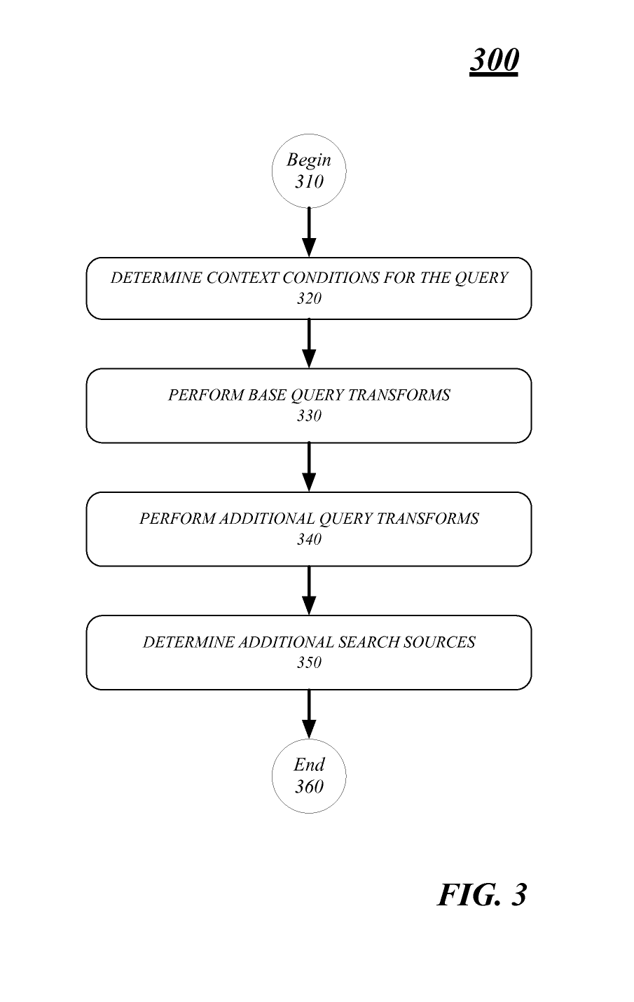

FIG. 3 illustrates one embodiment of a second logic flow 300. The second logic flow 300 may be representative of some or all of the operations executed by one or more embodiments described herein, such as the search query test system 100, for example. The second logic flow 300 may represent a process for query transformation. A query transformation may perform different operations. For example, a source that is associated with the query can be replaced, the query may be reformulated based on defined rules, additional queries may be formulated, different sources may be selected and the like.

Operations for the second logic flow 300 are initiated at block 310.

In block 320, context conditions for the query are determined. Context conditions are used to decide whether the behavior rule is appropriate for the context. For example, it may refer to a source that the rule is associated with, a user context object that must apply, or an app id (if one were available). Context conditions derive their context from available query properties. Queries may include arbitrary properties.

In block 330, any base query transforms are performed. Base query transforms replace the user text or query parameters of the base query. The source is not replaced. The results are placed in a results table with the same QueryID as the originating query object. According to an embodiment, this is the base results picked up by the core results. For example, the query: People:Puneet Narula may be replaced with People:Puneet Narula rankingModel=PeopleNameRank using the transform: People: { query} rankingModel=PeopleNameRank. According to an embodiment, when two replacement rules fire for a query, no replacement are made to the base query. Instead, the original base query is left untouched.

In block 340, additional query transforms are performed.

Additional Query Transforms are used to apply any valid transform to a query. Some transform rules will not change the source. For example, transform rule: <other><ppt>→ LocalSharePoint: {other} fileextension=ppt OR fileextension=pptx transforms LocalSharePoint:Monthly Report PPT into LocalSharePoint:Monthly Report fileextension=ppt OR fileextension=pptx.

Others transforms will change the source: <PeopleName>→People:{ query} rankingModel=PeopleNameRank. This will transform: LocalSharePoint:Puneet Narula into People:Puneet Narula rankingModel=PeopleNameRank.

In block 350, any additional search sources are determined. Any number of additional sources may be determined to which the search should be performed on/and or federated to. For example, a rule may specify that an additional enterprise source should be searched and that an outside federated source should be searched.

In block 360, the logic flow ends.

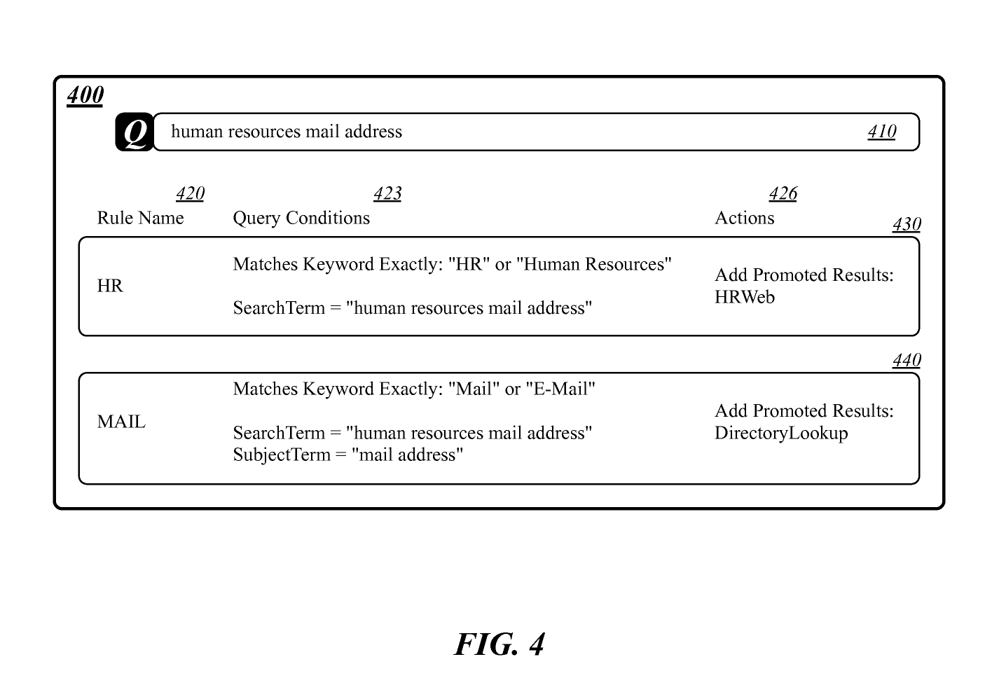

FIG. 4 illustrates a search test window 400, such as may be used by a user in performing a test of a search query. Search window 400 includes a search box 410 which, in this example, has entered into it—such as by a user—the search query “human resources mail address.” This may represent a user performing a test to see the consequences of performing the search “human resources mail address.”

Search window 400 includes two results, a first fired rule 430 and a second fired rule 440. Each fired rule is organized into three columns: the rule name 420, the query conditions 423, and the actions 426. The rule name 420 may consist of a user-created name which identified the rule. The query conditions 423 may comprise the predicate of the rule and the variables bound in the execution of the fired rule. The actions 426 may comprise what actions are taken, such as to modify or expand a search, as a consequence of the fired rule 426. It will be appreciated the listed actions may include actions—such as an action to run a parallel or additional search—which are not actually performed as the search system, when operating in a test mode, does not perform the searches generated by the application of rules to a search query.

In the illustrated example, the first fired rule 430 consists of a rule with the name “HR,” which fires when one of the keywords “HR” or “Human Resources” has an exact match within the search term. It will be appreciated that the concept of an exact keyword match may still ignore certain typographical elements such as case. As illustrated, the first fired rule 430 had a variable bound in its execution “SearchTerm” with the value “human resources mail address.” As further illustrated, the first fired rule 430 resulted in the action that promoted results would be added to the search, wherein the promoted results are a search of the “HRWeb,” which in this example may comprise a search domain for the human resources department.

In the illustrated example, the second fired rule 440 consists of a rule with the name “MAIL,” which fires when one of the keywords “Mail” or “E-Mail” has an exact match within the search term. As illustrated, the second fired rule 440 had two variables bound in its execution: as above, “SearchTerm” was bound to the value “human resources mail address” and the variable “SubjectTerm” was bound to the value “mail address,” indicating that the desired subject of the search is a mail address. It will be appreciated that some search systems—such as those search systems which may be accessed through a generated parallel search—may be able to use the desired subject of a search as part of their search process even if the general search system—such as a web search system—does not. As further illustrated, the second fired rule 440 resulted in the action that promoted results would be added to the search, wherein the promoted results are a directory lookup, which in this example may comprise a search of a directory system. It will be appreciated that in some embodiments, an action such as a directory lookup of a directory system may be performed even where the primary search was over the World Wide Web and the directory system is not accessible through the World Wide Web. In general, the creation of parallel searches may include creating searches of data storage systems which would not otherwise be included in the search.

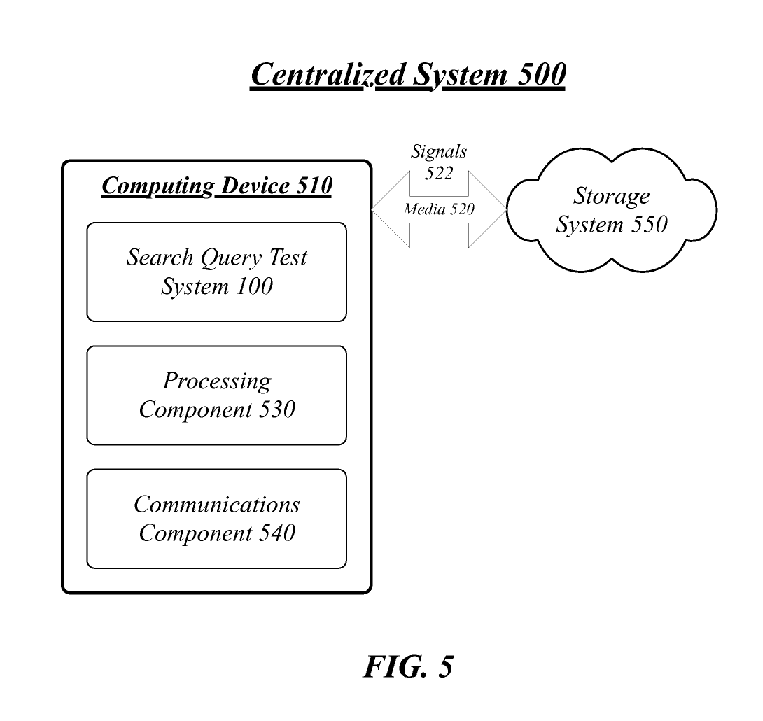

FIG. 5 illustrates a block diagram of a centralized system 500. The centralized system 500 may implement some or all of the structure and/or operations for the search query test system 100 in a single computing entity, such as entirely within a single device 510.

The device 510 may comprise any electronic device capable of receiving, processing, and sending information for the search query test system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 510 may execute processing operations or logic for the search query test system 100 using a processing component 530. The processing component 530 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 530 may execute communications operations or logic for the system 100 using communications component 540. The communications component 540 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 540 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 520 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 510 may communicate with a storage system 550 over a communications media 520 using communications signals 522 via the communications component 540. The storage system may be internal or external to the device 510 as desired for a given implementation. In some embodiments, the storage system 550 may comprise a storage system 550 used by a search system as part of performing a search. As such, the signals 522 sent over media 520 may comprise the search query test system 100 accessing the same data, or a portion of the same data, used by the search system in its searches. For example, in some embodiments, the storage system 500 may store the context information for the search system, such that signals 522 sent over media 520 comprise requests to retrieve an execution context for a query.

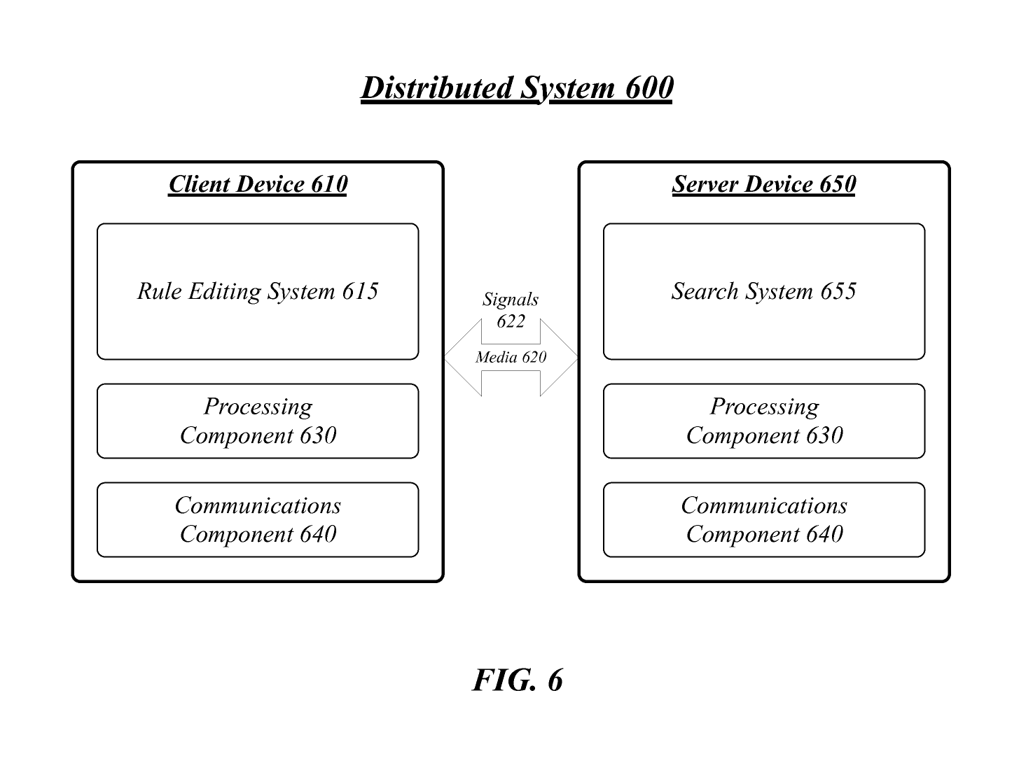

FIG. 6 illustrates a block diagram of a distributed system 600. The distributed system 600 may distribute portions of the structure and/or operations for the search query test system 100 across multiple computing entities. Examples of distributed system 600 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 600 may comprise a client device 610 and a server device 650. In general, the client device 610 and the server device 650 may be the same or similar to the computing device 510 as described with reference to FIG. 5. For instance, the client device 510 and the server device 650 may each comprise a processing component 630 and a communications component 640 which are the same or similar to the processing component 530 and the communications component 540, respectively, as described with reference to FIG. 5. In another example, the devices 610, 650 may communicate over a communications media 620 using communications signals 622 via the communications components 640.

The client device 610 and server device 650 may comprise or employ one or more client programs that operate to perform various methodologies in accordance with the described embodiments. In one embodiment, for example, the server device 650 may host the search system 655 which may, when run in an execution mode, perform searches, such as for a plurality of users. The search system 655 may be operative to be run in a test mode in which a portion of the search pipeline is used to perform a test, but wherein an actual search is not performed and search results are not generated. Client device 610 may comprise a rule editing system 615 for receiving query rules from a user, editing query rules by a user, submitting query rules to the search system 655 in a test mode, and receiving the result of the test mode analysis. Server device 650 may therefore comprise a search system 655 operative to run in either an execution mode or test mode, wherein the execution mode may be used by users to perform searches, and wherein the test mode may be used by users to test query rules by using a client device 610 which comprises the rule editing system 615. As such, the client device 610 may comprise a client device operative to assist a user in performing query rule tests by interacting with the search system 655 in a test mode.

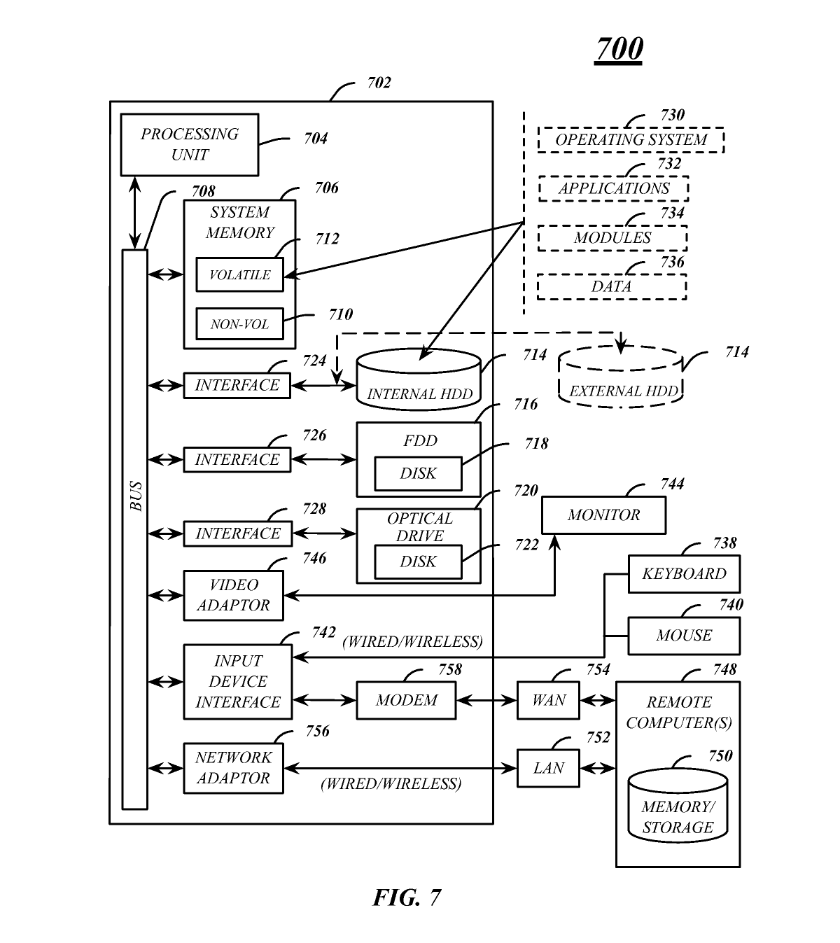

FIG. 7 illustrates an embodiment of an exemplary computing architecture 700 suitable for implementing various embodiments as previously described. As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In one embodiment, the computing architecture 700 may comprise or be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. The embodiments are not limited in this context.

The computing architecture 700 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors. Dual microprocessors and other multi-processor architectures may also be employed as the processing unit 704. The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736.

The one or more application programs 732, other program modules 734, and program data 736 can include, for example, the context component 110, the rules component 120, the transformation component 130, the results component 140, and the display component 150.

A user can enter commands and information into the computer 702 through one or more wire/wireless input devices, for example, a keyboard 738 and a pointing device, such as a mouse 740. Other input devices may include a microphone, an infra-red (IR) remote control, a joystick, a game pad, a stylus pen, touch screen, or the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

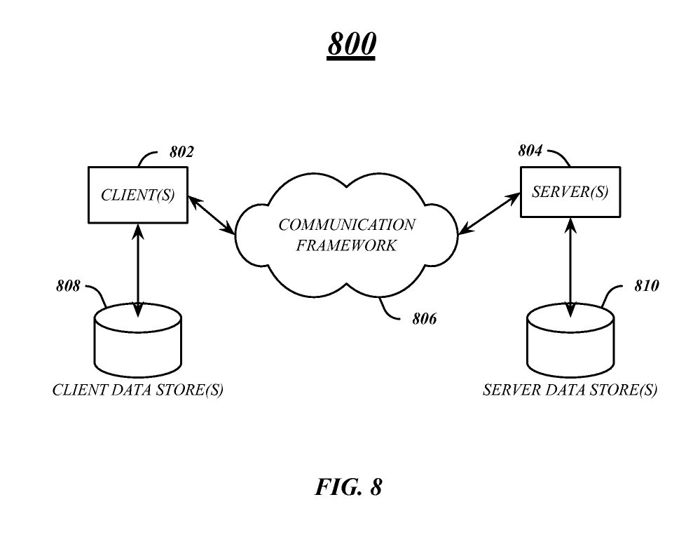

FIG. 8 illustrates a block diagram of an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, and so forth. The embodiments, however, are not limited to implementation by the communications architecture 800.

As shown in FIG. 8, the communications architecture 800 comprises includes one or more clients 802 and servers 804. The clients 802 may implement the client systems 310, 400. The servers 804 may implement the server system 330. The clients 802 and the servers 804 are operatively connected to one or more respective client data stores 808 and server data stores 810 that can be employed to store information local to the respective clients 802 and servers 804, such as cookies and/or associated contextual information.

The clients 802 and the servers 804 may communicate information between each other using a communication framework 806. The communications framework 806 may implement any well-known communications techniques and protocols, such as those described with reference to systems 300, 400 and 700. The communications framework 806 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 806 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a logic device;
a context component operative on the logic device to receive a search query and determine a query execution context;
a rules component operative to receive the determined query execution context and the search query and to determine a set of fired rules;
a transformation component operative to receive the set of fired rules, the search query, and the query execution context, and determine one or more transformed queries; and
a results component operative to determine a search query analysis based on the one or more transformed queries, wherein the search query analysis does not depend on performing a search using the search query.

2. The apparatus of claim 1, further comprising:
a display component operative to receive the search query analysis and display the search query analysis for a user, the displayed search query analysis showing the set of fired rules in association with the one or more transformed queries.

3. The apparatus of claim 2, wherein the displayed search query analysis includes a display of variables from the query execution context used in determining the one or more transformed queries.

4. The apparatus of claim 1, wherein at least one of the fired rules comprises a transformation rule, the one or more transformed queries comprising a transformation of the search query into a different query according to the transformation rule, the search query analysis comprising the different query.

5. The apparatus of claim 1, wherein at least one of the fired rules comprises a parallel rule, the one or more transformed queries comprising a new query created from the search query according to the parallel rule, the search query analysis comprising the new query.

6. The apparatus of claim 1, wherein at least one of the fired rules comprises a federation rule, the one or more transformed queries comprising a plurality of federated queries created from the search query according to the federated rule, the search query analysis comprising the plurality of federated queries.

7. The apparatus of claim 1, wherein the determined query execution context includes active rules and inactive rules, wherein the inactive rules are included in the determination of the set of fired rules.

8. The apparatus of claim 1, wherein the query execution context includes an ordering group comprising a plurality of rules with a specified order of evaluation, wherein at least one of the plurality of rules within the ordering group is fired and has an associated stop action, wherein the search query analysis includes an indication that one or more of the plurality of rules within the ordering group was rendered conditionally inactive by the stop action.

9. A computer-implemented method, comprising:
receiving a search query;
determining a query execution context based on the search query;
determining a set of fired rules based on the determined query execution context and the search query;
determining one or more transformed queries based on the set of fired rules, the search query, and the query execution context; and
determining a search query analysis based on the one or more transformed queries, wherein the search query analysis does not depend on performing a search using the search query.

10. The computer-implemented method of claim 9, further comprising:
displaying the search query analysis for a user, the displayed search query analysis showing the set of fired rules in association with the one or more transformed queries.

11. The computer-implemented method of claim 9, wherein the search query analysis includes variables from the query execution context used in determining the one or more transformed queries.

12. The computer-implemented method of claim 9, wherein at least one of the fired rules comprises a transformation rule, the one or more transformed queries comprising a transformation of the search query into a different query according to the transformation rule, the search query analysis comprising the different query.

13. The computer-implemented method of claim 9, wherein at least one of the fired rules comprises a parallel rule, the one or more transformed queries comprising a new query created from the search query according to the parallel rule, the search query analysis comprising the new query.

14. The computer-implemented method of claim 9, wherein at least one of the fired rules comprises a federation rule, the one or more transformed queries comprising a plurality of federated queries created from the search query according to the federated rule, the search query analysis comprising the plurality of federated queries.

15. The computer-implemented method of claim 9, wherein the determined query execution context includes active rules and inactive rules, wherein the inactive rules are included in the determination of the set of fired rules.

16. At least one computer-readable storage medium comprising instructions that, when executed, cause a system to:
receive a search query;
determine a query execution context based on the search query;
determine a set of fired rules based on the determined query execution context and the search query;
determine one or more transformed queries based on the set of fired rules, the search query, and the query execution context;
determine a search query analysis based on the one or more transformed queries, wherein the search query analysis does not depend on performing a search using the search query; and
display the search query analysis for a user, the displayed search query analysis showing the set of fired rules in association with the one or more transformed queries.

17. The at least one computer-readable storage medium of claim 16, wherein the displayed search query analysis includes a display of variables from the query execution context used in determining the one or more transformed queries.

18. The at least one computer-readable storage medium of claim 16, wherein at least one of the fired rules comprises a transformation rule, the one or more transformed queries comprising a transformation of the search query into a different query according to the transformation rule, the search query analysis comprising the different query.

19. The at least one computer-readable storage medium of claim 16, wherein at least one of the fired rules comprises a parallel rule, the one or more transformed queries comprising a new query created from the search query according to the parallel rule, the search query analysis comprising the new query.

20. The at least one computer-readable storage medium of claim 16, wherein the determined query execution context includes active rules and inactive rules, wherein the inactive rules are included in the determination of the set of fired rules.
